(19) United States
(12) Patent Application Publication
(10) Pub. No.: US 2025/0174836 A1
(43) Pub. Date: May 29, 2025

(54) POWER SUPPLY DEVICE

(71) Applicant: TOYOTA JIDOSHA KABUSHIKI KAISHA, Toyota-shi (JP)

(72) Inventors: Yuki SHIMIZU, Nagoya-shi (JP); Masakazu KOUDA, Anjo-shi (JP)

(73) Assignee: TOYOTA JIDOSHA KABUSHIKI KAISHA, Toyota-shi (JP)

(21) Appl. No.: 18/776,505

(22) Filed: Jul. 18, 2024

(30) Foreign Application Priority Data
Nov. 29, 2023 (JP) 2023-201654

(51) Int. Cl. H01M 50/509; B60L 58/19; H01M 50/528

(52) U.S. Cl. CPC H01M 50/509; B60L 58/19; H01M 50/528

(57) ABSTRACT

A power supply device includes a first battery, a second battery, a first relay electrically connecting and disconnecting between the positive electrode of the first battery and the positive electrode of the second battery, a second relay that electrically connects and disconnects between the negative electrode of the first battery and the positive electrode of the second battery, a third relay that electrically connects and disconnects between the negative electrode of the first battery and the negative electrode of the second battery, and a control device that controls operations of the first relay, the second relay, and the third relay, and the control device includes at least one processor, a first AND gate device, and a second AND gate device. The first AND gate element and the second AND gate element are configured to drive corresponding relays in response to a combination of the drive signal and the enable signal.

### CROSS-REFERENCE TO RELATED APPLICATION

This application claims priority to Japanese Patent Application No. 2023-201654 filed on Nov. 29, 2023, incorporated herein by reference in its entirety.

### BACKGROUND

### 1. Technical Field

The technology disclosed herein relates to a power supply device.

### 2. Description of Related Art

Japanese Unexamined Patent Application Publication No. 2019-118221 (JP 2019-118221 A) discloses a power supply device. The power supply device includes a first battery, a second battery, and a plurality of relays. The relays include a first relay, a second relay, and a third relay. The first relay electrically connects and disconnects the positive electrode of the first battery and the negative electrode of the second battery. The second relay electrically connects and disconnects the positive electrode of the first battery and the positive electrode of the second battery. The third relay electrically connects and disconnects the negative electrode of the first battery and the negative electrode of the second battery.

### SUMMARY

In the power supply device described above, the two batteries can be connected in parallel by turning on (that is, closing) the first relay and the third relay in a state in which the second relay is turned off (that is, opened). In addition, the two batteries can be connected in series by turning on the second relay in a state in which the first relay and the third relay are turned off. On the other hand, there is a concern that both electrodes of the first battery and/or the second battery are short-circuited if at least one of the first relay and the third relay and the second relay are turned on at the same time. The present specification provides a technique for avoiding such short-circuiting.

The technology disclosed in an aspect of the present specification is embodied as a power supply device. The power supply device includes:
a first battery;
a second battery;
a first relay that electrically connects and disconnects between a positive electrode of the first battery and a positive electrode of the second battery;
a second relay that electrically connects and disconnects between a negative electrode of the first battery and the positive electrode of the second battery;
a third relay that electrically connects and disconnects between the negative electrode of the first battery and a negative electrode of the second battery; and
a control device that controls operation of the first relay, the second relay and the third relay. The control device includes at least one processor, a first AND gate element, and a second AND gate element.

The at least one processor is configured to output a first drive signal for the first relay and the third relay, a second drive signal for the second relay, and at least one permission signal. The at least one permission signal includes at least one of a first permission signal for permitting turning on the first relay and the third relay and a second permission signal for permitting turning on the second relay.

The first AND gate element is configured to further receive one of the first permission signal and an inverted signal of the second permission signal in addition to the first drive signal, and to output an AND signal of the received signals to the first relay and the third relay.

The second AND gate element is configured to further receive one of an inverted signal of the first permission signal and the second permission signal in addition to the second drive signal, and to output an AND signal of the received signals to the second relay.

According to the above configuration, each relay of the power supply device is not driven (in particular, turned on) only by the first drive signal or the second drive signal, but is driven for the first time by a combination with the permission signal. Consequently, unintended driving of each relay is suppressed, and short-circuiting between both electrodes of the first battery and the second battery can be avoided.

In one aspect of the present technology,
the at least one processor of the power supply device may be configured to output each of the first permission signal and the second permission signal as the at least one permission signal;
the first AND gate element may be configured to receive the first drive signal and the first permission signal, and to output an AND signal of the received signals to the first relay and the third relay; and
the second AND gate element may be configured to receive the second drive signal and the second permission signal, and to output an AND signal of the received signals to the second relay.

That is, two respective permission signals may be used for the two drive signals.

In one aspect of the present technology,
the at least one processor of the power supply device may be configured to output only one of the first permission signal and the second permission signal as the at least one permission signal; and
a NOT gate element that receives the first permission signal or the second permission signal and that outputs an inverted signal of the received signal may be provided between the processor and the first AND gate element or between the processor and the second AND gate element.

That is, a single permission signal and an inverted signal of the permission signal may be used for the two drive signals. According to such a configuration, unintended driving of each relay can be suppressed more reliably.

In one aspect of the present technology,
the at least one processor of the power supply device may include a first processor that outputs the first drive signal or the second drive signal and a second processor that outputs the at least one permission signal.

According to such a configuration, unintended driving of each relay can be reliably suppressed, even when one of the processors malfunctions.

In one aspect of the present technology,
the at least one processor of the power supply device may switch the first drive signal or the second drive signal after switching the at least one permission signal when turning on the first relay and the third relay or the second relay.

According to such a configuration, unintended driving of each relay can be reliably suppressed, as both the drive signal and the permission signal are not erroneously output when the processor or other component malfunctions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a power supply device 10 according to a first embodiment;

FIG. 2 is a block diagram illustrating a configuration of the control device 18 according to the first embodiment;

FIG. 3 is a time chart showing the status of each signal and each relay 16a, 16b, 16c in Embodiment 1;

FIG. 4 is a block diagram illustrating a configuration of the control device 118 according to the second embodiment;

FIG. 5 is a time chart showing the status of each signal and each relay 16a, 16b, 16c in Embodiment 2; the same applies to Embodiment 3; and

FIG. 6 is a block diagram illustrating a configuration of the control device 218 according to the third embodiment.

### DETAILED DESCRIPTION OF EMBODIMENTS

### Example 1

The power supply device 10 of the first embodiment will be described with reference to the drawings. As an example, the power supply device 10 of the present embodiment can be employed in an electrified vehicle. Note that electrified vehicle is not limited to Battery Electric Vehicle (BEV), and may be similarly employed in other types of electrified vehicle. Further, the configuration described in the present embodiment is not limited to electrified vehicle, and can be similarly employed in other types of apparatuses and facilities using electric power as a power source.

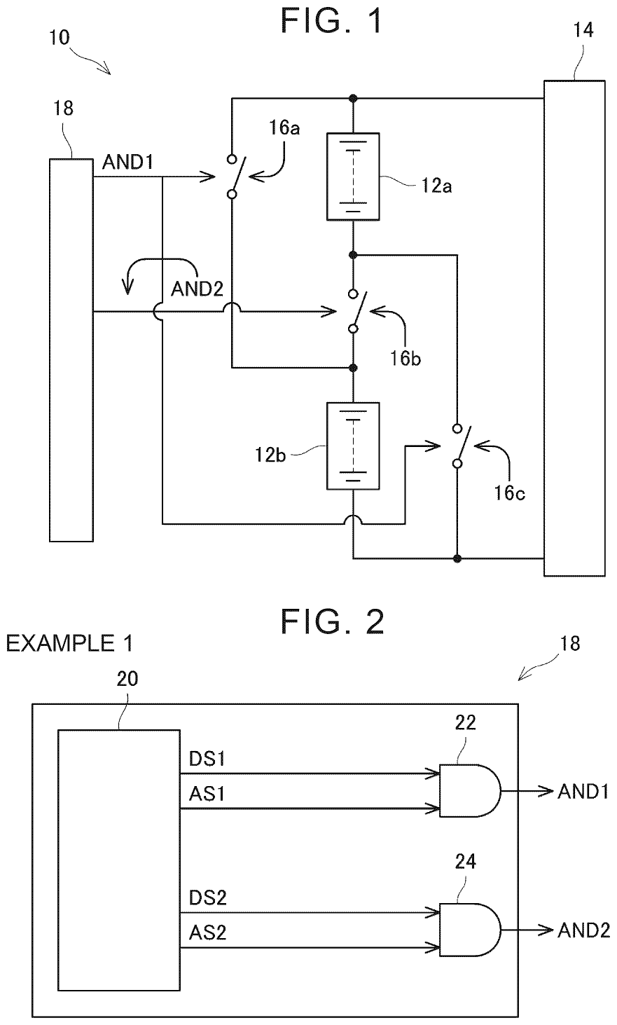

As illustrated in FIG. 1, the power supply device 10 includes a first battery 12a, a second battery 12b, a power unit 14, a first relay 16a, a second relay 16b, a third relay 16c, and a control device 18. The first battery 12a and the second battery 12b are high-voltage batteries. Here, the high voltage means an operating voltage exceeding the DC 60V. The first battery 12a and the second battery 12b incorporate a plurality of secondary battery cells, and may be, for example, a lithium-ion battery or an all-individual battery.

The power supply device 10 is mounted on electrified vehicle and supplies power to the power unit 14 of electrified vehicle. Although not particularly limited, the power unit 14 includes an electric motor that drives wheels, an inverter that controls power supplied to the electric motor, and the like.

The first relay 16a is configured to electrically connect and disconnect the positive electrode of the first battery 12a and the positive electrode of the second battery 12b. The second relay 16b is configured to electrically connect and disconnect the negative electrode of the first battery 12a and the positive electrode of the second battery 12b. The third relay 16c is configured to electrically connect and disconnect the negative electrode of the first battery 12a and the negative electrode of the second battery 12b. In one embodiment, the first relay 16a, the second relay 16b, and the third relay 16c are electromagnetically driven reed relays. As will be described in detail later, the first relay 16a and the third relay 16c are driven in accordance with a first AND signal (AND1) output from the control device 18, and the second relay 16b is driven in accordance with a second AND signal (AND2) output from the control device 18.

The control device 18 is a device that switches the connection mode of the first battery 12a and the second battery 12b between the parallel connection and the series connection by controlling the operations of the three relays 16a, 16b, 16c. The switching of the connecting mode is performed in accordance with the use status of electrified vehicle on which the power supply device 10 is mounted. For example, when electrified vehicle is running, the first battery 12a and the second battery 12b are connected in series, and when electrified vehicle is charged (that is, when the power supply device 10 is charged), the first battery 12a and the second battery 12b are connected in parallel.

As illustrated in FIG. 2, the control device 18 includes a processor 20, a first AND gate element 22, and a second AND gate element 24. The processor 20 is configured to provide a first drive signal (DS1), a second drive signal (DS2), a first permission signal (AS1), and a second permission signal (AS2). The first drive signal and the first permission signal are input to first AND gate element 22, and the second drive signal and the second permission signal are input to second AND gate element 24.

The first drive signal is a drive signal for the first relay 16a and the third relay 16c, and is a binary signal that alternatively indicates an on command (HIGH) and an off command (LOW). The second drive signal is a drive signal for the second relay 16b, and is a binary signal that alternatively indicates an on command (HIGH) and an off command (LOW). The first permission signal is a signal for permitting the first relay 16a and the third relay 16c to be turned on, and is a binary signal that alternatively indicates a permission command (HIGH) and a prohibition command (LOW). The second permission signal is a signal for permitting the second relay 16b to be turned on, and is a binary signal that alternatively indicates a permission command (HIGH) and a prohibition command (LOW).

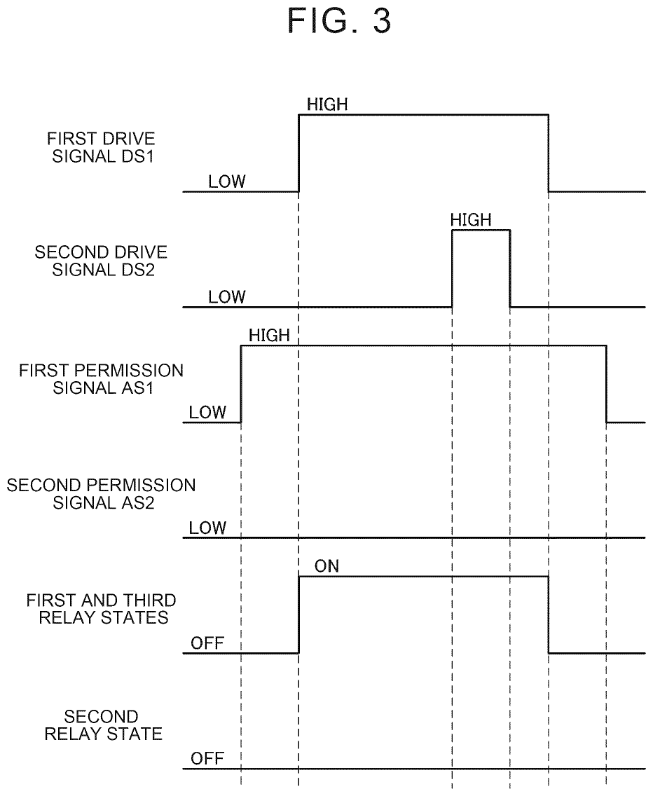

The first AND gate element 22 receives the first drive signal and the first permission signal, and outputs a first AND signal which is a logical product of the first drive signal and the first permission signal. As described above, the first AND signal is inputted to the first relay 16a and the third relay 16c to drive the first relay 16a and the third relay 16c. Thus, as shown in FIG. 3, the first relay 16a and the third relay 16c are turned on only when the first drive signal indicates an on command (HIGH) and the first permission signal indicates a permission command (HIGH). On the other hand, the off of the first relay 16a and the third relay 16c is achieved by only one of the off command (LOW) of the first drive signal and the prohibition command (LOW) of the first permission signal.

second AND gate element 24 receives the second drive signal and the second permission signal, and outputs a second AND signal which is a logical product thereof. As described above, the second AND signal is inputted to the second relay 16b to drive the second relay 16b. Thus, the second relay 16b is turned on only when the second drive signal indicates an on command (HIGH) and the second permission signal indicates permission (HIGH). On the other hand, the off of the second relay 16b is achieved by only one of the off command (LOW) of the second drive signal and the prohibition command (LOW) of the second permission signal. That is, as shown in FIG. 3, while the second permission signal indicates the prohibition command, even if the second drive signal unintentionally indicates the on command, the off state of the second relay 16b is maintained.

As described above, in the power supply device 10 of the present embodiment, the relay 16a, 16b, 16c are not driven (in particular, turned on) only by the first drive signal or the second drive signal, but are driven only by combining the first permission signal or the second permission signal, respectively. As a result, unintended driving of the relay 16a, 16b, 16c is prevented, and short-circuiting between both electrodes in the first battery 12a and the second battery 12b can be avoided. When an excessive current flows through any of the relay 16a, 16b, 16c, damage to the relay 16a, 16b, 16c is avoided.

### Example 2

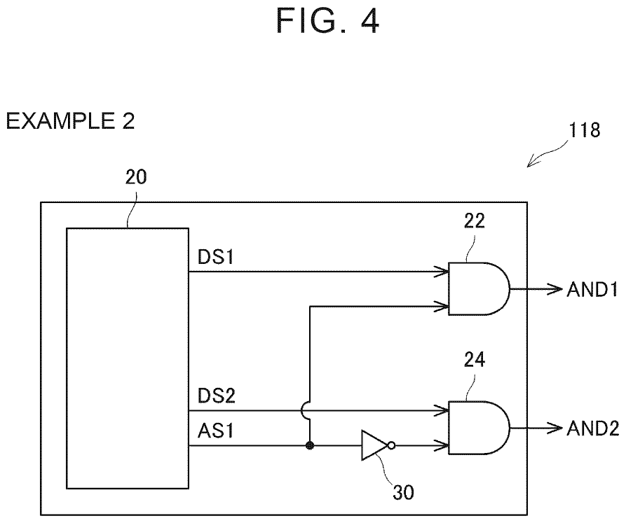

Referring to FIG. 4, a power supply device of a second embodiment will be described. In the power supply device of the present embodiment, the control device 18 in the power supply device 10 of the first embodiment described above is changed to the control device 118 shown in FIG. 4. Since the other points are the same in both embodiments, a repetitive description will be omitted.

As illustrated in FIG. 4, the control device 118 according to the second embodiment includes a processor 20, a first AND gate element 22, a second AND gate element 24, and a NOT gate element 30. NOT gate element 30 is provided between the processor 20 and second AND gate element 24. NOT gate element 30 receives the first permission signal (AS1) output from the processor 20, and outputs the inverted signal to second AND gate element 24.

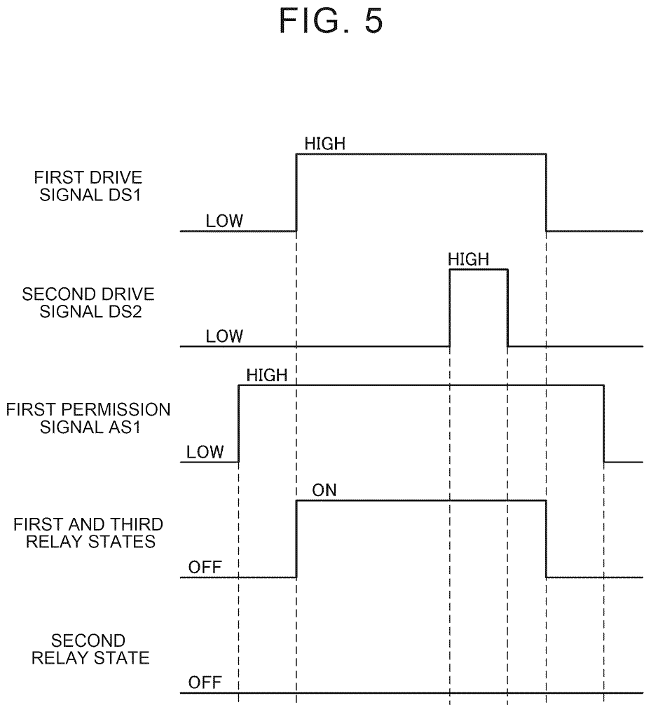

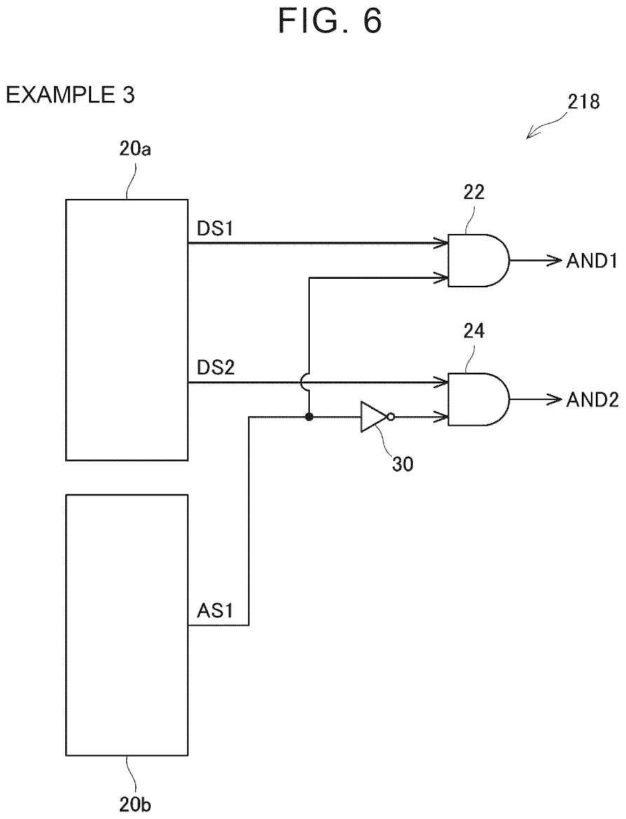

Therefore, in the control device 118 according to the second embodiment, second AND gate element 24 receives the second drive signal (DS2) and the inverted signal of the first permission signal (AS1), and outputs the second AND signal (AND2), which is the logical product thereof, to the second relay 16b. According to such a configuration, as shown in FIG. 5, the second relay 16b is turned on only when the second drive signal indicates the on command (HIGH) and the first permission signal indicates the prohibition command (LOW). That is, the second relay 16b is permitted to be turned on only when the first relay 16a and the third relay 16c are prohibited from being turned on. Conversely, when the first permission signal indicates a permission command (HIGH), the second relay 16b is disabled and the first relay 16a and the third relay 16c are enabled.

As described above, in the control device 118 according to the second embodiment, the unintended driving (turning on) of each relay 16a, 16b, 16c can be reliably suppressed by using the single first permission signal and the inverted signal for the two drive signals. As a modification, NOT gate element 30 may be provided between the processor 20 and first AND gate element 22. The processor 20 may be configured to output the second permission signal to the second AND gate element 24 and NOT gate element 30, and NOT gate element 30 may be configured to output the inverted signal of the second permission signal to the first AND gate element 22.

Although not particularly limited, as shown in FIG. 5, the processor 20 in the second embodiment is configured to switch the first drive signal after switching the first permission signal when the first relay 16a and the third relay 16c are turned on. According to such a configuration, when the processor 20 or other components malfunction, both the first drive signal and the first permission signal are not erroneously output. Then, unintended driving of the first relay 16a and the third relay 16c can be reliably suppressed.

### Example 3

Referring to FIG. 6, a power supply device of a third embodiment will be described. In the power supply device of the present embodiment, the control device 18 in the power supply device 10 of the first embodiment described above is changed to the control device 218 shown in FIG. 6. Since the other points are the same in both embodiments, a repetitive description will be omitted.

As illustrated in FIG. 6, the control device 218 according to the third embodiment includes a first processor 20a, a second processor 20b, a first AND gate element 22, a second AND gate element 24, and a NOT gate element 30. The first processor 20a outputs a first drive signal (DS1) and a second drive signal (DS2), and the second processor 20b outputs a first permission signal (AS1). NOT gate element 30 is provided between the second processor 20b and second AND gate element 24. NOT gate element 30 receives the first permission signal outputted from the second processor 20b, and outputs the inverted signal to second AND gate element 24.

The control device 218 according to the third embodiment is provided with a second processor 20b that outputs a first permission signal independently of the first processor 20a that outputs two drive signals. According to such a configuration, even when one of the two processors 20a, 20b malfunctions, unintended driving of the each relay 16a, 16b, 16c can be reliably suppressed.

The technical elements described in this specification or in the drawings may be used alone or in various combinations, and are not limited to the combinations described in the claims at the time of filing. Further, the technology illustrated in the present specification or the drawings can achieve a plurality of objects at the same time, and has technical usefulness by achieving one of the objects.

What is claimed is:

1. A power supply device comprising:
a first battery;
a second battery;
a first relay that electrically connects and disconnects between a positive electrode of the first battery and a positive electrode of the second battery;
a second relay that electrically connects and disconnects between a negative electrode of the first battery and the positive electrode of the second battery;
a third relay that electrically connects and disconnects between the negative electrode of the first battery and a negative electrode of the second battery; and
a control device that controls operation of the first relay, the second relay and the third relay, wherein:
the control device includes at least one processor, a first AND gate element, and a second AND gate element;
the at least one processor is configured to output a first drive signal for the first relay and the third relay, a second drive signal for the second relay, and at least one permission signal;
the at least one permission signal includes at least one of a first permission signal for permitting turning on the first relay and the third relay and a second permission signal for permitting turning on the second relay;
the first AND gate element is configured to further receive one of the first permission signal and an inverted signal of the second permission signal in addition to the first drive signal, and to output an AND signal of the received signals to the first relay and the third relay; and
the second AND gate element is configured to further receive one of an inverted signal of the first permission signal and the second permission signal in addition to the second drive signal, and to output an AND signal of the received signals to the second relay.

2. The power supply device according to claim 1, wherein:
the at least one processor is configured to output each of the first permission signal and the second permission signal as the at least one permission signal;
the first AND gate element is configured to receive the first drive signal and the first permission signal, and to output an AND signal of the received signals to the first relay and the third relay; and
the second AND gate element is configured to receive the second drive signal and the second permission signal, and to output an AND signal of the received signals to the second relay.

3. The power supply device according to claim 1, wherein:
the at least one processor is configured to output only one of the first permission signal and the second permission signal as the at least one permission signal; and
a NOT gate element that receives the first permission signal or the second permission signal and that outputs an inverted signal of the received signal is provided between the processor and the first AND gate element or between the processor and the second AND gate element.

4. The power supply device according to claim 1, wherein the at least one processor includes a first processor that outputs the first drive signal or the second drive signal and a second processor that outputs the at least one permission signal.

5. The power supply device according to claim 1, wherein the at least one processor switches the first drive signal or the second drive signal after switching the at least one permission signal when turning on the first relay and the third relay or the second relay.
